(19) United States
(12) Patent Application Publication
(10) Pub. No.: US 2025/0238823 A1
(43) Pub. Date: Jul. 24, 2025

(54) SIMULATING A/B TESTING THROUGH LARGE LANGUAGE MACHINE-LEARNED MODELS

(71) Applicant: Maplebear Inc., San Francisco, CA (US)

(72) Inventors: Tilman Drerup, Palo Alto, CA (US); Jiuyun Zhang, Mountain View, CA (US); Levi Boxell, Brownsburg, IN (US)

(21) Appl. No.: 18/421,888

(22) Filed: Jan. 24, 2024

(51) Int. Cl. G06Q 30/0202; G06F 40/20

(52) U.S. Cl. CPC G06Q 30/0202; G06F 40/20

(57) ABSTRACT

An online system uses Large Language Models (LLM's) to simulate the behavior of real customers in such tests as a low-cost way to simulate A/B tests. A prompt is constructed for a given customer. The prompt is sent to the LLM with a request to infer the predicted outcome of a treatment. The online system collects the output. Statistical analyses are run based on the output of the previous step to determine which treatment to select for the user.

### BACKGROUND

Companies rely on A/B testing to evaluate different product variants and algorithms. Running such A/B tests is costly for various reasons. A/B testing requires multiple resources such as designers, developers, and analysts to create various testing treatments to implement on websites or applications. This prevents such designers, developers, and analysts from other potentially important tasks. Additionally, while testing several treatments with users, there is a risk that a testing treatment may perform poorly among users, which in turn can lead to a decrease in conversion rates or user engagement.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 is an example system architecture for an LLM system diagram for simulating A/B testing, in accordance with one or more embodiments.

FIG. 4 is an example system architecture for an LLM system diagram that incorporates back testing, in accordance with one or more embodiments.

FIG. 5 is an example prompt tuning architecture, in accordance with one or more embodiments.

FIG. 6 is a flowchart for a treatment testing module, in accordance with one or more embodiments.

### DETAILED DESCRIPTION

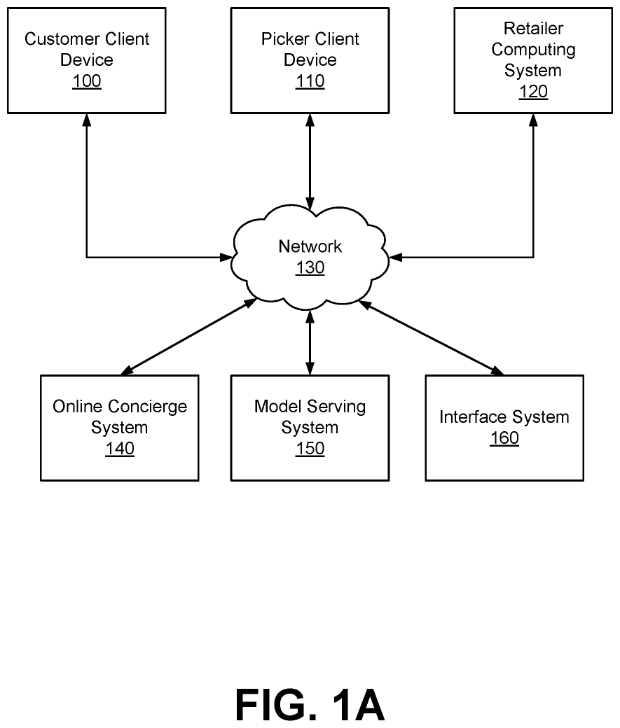

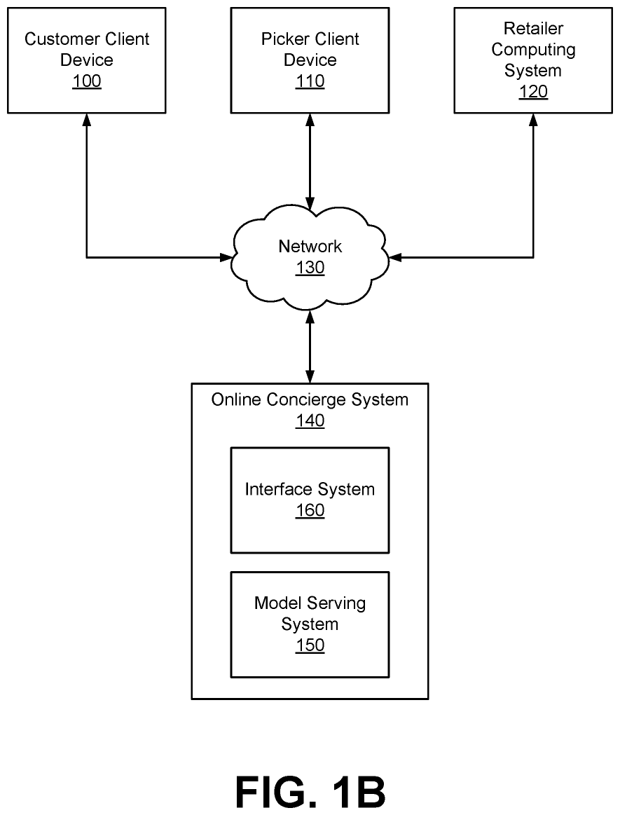

FIG. 1A illustrates an example system environment for an online concierge system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the User 1nd may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

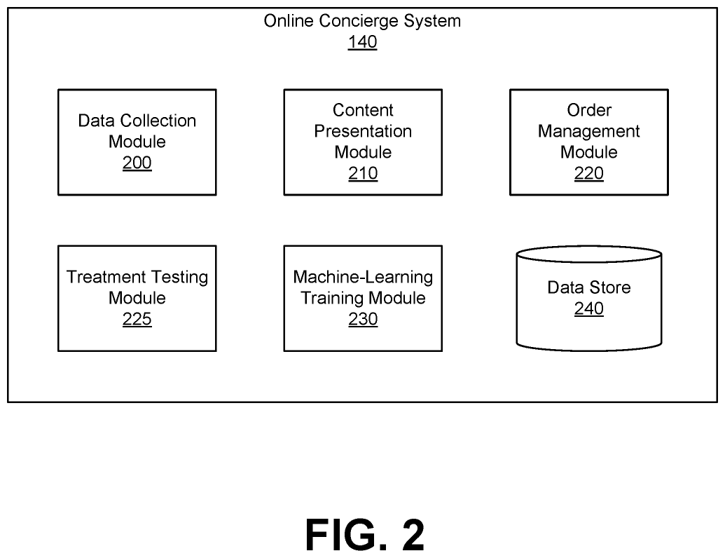

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 150 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one embodiment, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one embodiment, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the User 1nd context obtained from the structured index of the external data. In one instance, the context in the prompt includes portions of the structured indices as contextual information for the query. The interface system 160 obtains one or more responses from the model serving system 160 and synthesizes a response to the query on the external data. While the online concierge system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

In one embodiment, the online concierge system 140 described herein simulates A/B testing experiments in conjunction with one or more large-scale machine-learned models deployed by the online concierge system 140. Companies utilize A/B testing to compare variations of an element to improve customer's experiences and increase engagement. A/B testing evaluates variations in color schemes, button placement, navigation menus, or even entire layouts. For example, such companies might run an A/B test to evaluate the click-through-rates of different email campaigns or website designs. Companies may also run A/B tests to improve site navigation and user ability by enhancing the sequence of interfaces presented to the user during the user's experience with the online concierge system 140. For example, the A/B tests can test several iterations of the interface elements presented to the user during a single experience with the online concierge system 140. Running such A/B tests is costly for various reasons. Direct costs come in the form of exposing some customers to subpar experiences, sometimes for extended periods of time. There are also engineering costs of running multiple variants of a product experience in parallel that a company may want to avoid. At the same time, testing requires real data and insight on user preferences to formulate data-driven decisions. Thus, current methods require costly resources and may reduce conversion rates and other user engagements while the test is active.

Thus, in one embodiment, the online concierge system 140 simulates A/B testing in conjunction with a large-scale machine learned models like an LLM. In this manner, the online concierge system 140 uses LLM's to simulate the behavior of real customers which leads to a low-cost way to simulate A/B testing. By simulating A/B testing in conjunction with a large-scale machine-learned concierge system, the online concierge system 140 receives data driven insight on user engagement without the traditional high costs associated with A/B testing. In this manner, the online concierge system 140 utilizes LLM's capacity to create realistic simulations of human behavior.

Specifically, as described in more detail below in conjunction with treatment testing module 225 of FIG. 2, the online concierge system 140 obtains a user history database that describes a user's past behavior. The treatment testing module 225 receives at least two different testing treatments. The treatments are a simulation that the user may engage and respond to from the user experience with the online concierge system 140. For example, one treatment may hypothesize presenting a user with 15% coupon, and another treatment may hypothesize presenting a user with 30% coupon. The treatment testing module 225 is instructed to generate a prompt for a LLM to generate predictions of how a user responds to a treatment in terms of a desired output type. An output type indicates how the user responds to an experience with the online concierge system 140 for at least a treatment. The experience with the online concierge system 140 comprises at least a sequence of actions or events presented to the user during the interaction with the online concierge system 140. For example, the sequence of actions or events may include clicking on an item, adding the item to the user's order, clicking on a checkout button to initiate the checkout process, clicking to add an item post-checkout. As another example, the treatment testing module 225 may generate predictions of a received treatment in terms of a click-through rate (CTR) for the received treatment. The treatment testing module 225 may generate a prompt like “Based on User 1's past CTR for a similar treatment, what is the estimated CTR of User 1 for the received treatment?” The treatment testing module 225 provides the instruction to the model serving system. The treatment testing module 225 receives a response from the model serving system, with at least one or more outputs, where an output is a prediction of how the user will respond to each received treatment. For example, the treatment testing module 225 determines an ideal treatment for the user based on the received output and selects the ideal treatment accordingly.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one embodiment, as illustrated in the example system environment in FIG. 1B, the model serving system 150 and/or the interface system 160 is managed and deployed by the entity managing the online concierge system 140.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The treatment testing module 225 simulates A/B testing for one or more users for two or more treatments—the simulation simulates how a user will interact or respond to each of the two or more treatments. For a particular user, the treatment testing module 225 obtains the user's history database to describe the user's past behavior. For example, the user's past behavior may comprise contextual data such as data of the client device associated with the user's geographical data. An example of the user's history database behavior may be a database with the past treatments that the user engaged with. The user history database can be either very sparse and describe high-level characteristics of the customer or very detailed and contain a description of their past behavior on the platform, including the products they purchased, looked at, or the emails they clicked on. In effect, this data would be used to create a profile of a customer on the side of the LLM. The level of detail would depend on the application and test in question. The treatment testing module 225 also receives at least two different testing treatments.

The treatments are a simulation that the user may engage and respond to during the user's experience with the online concierge system 140. For example, a treatment is a variation of coupons to present to the user through the user experience. A first treatment may be presenting the user with a 15% off coupon interface, a second treatment may be presenting the user with a 30% off coupon interface, and a third treatment may be presenting the user with no coupon interface. A treatment may also be a variation of interface themes presented during the user's experience.

In some embodiments, the treatment testing module 225 is instructed to generate a prompt for a machine learned language model (e.g., LLM's) to generate predictions of how a user responds to a treatment in terms of a desired output type. The treatment testing module 225 generates predictions of a received treatment to the users. The treatment testing module 225 may generate a prompt like “Based on User 1's history data and the treatment of experiences presented to the user, will the user add items to the user's cart? “An output type indicates a metric that measures how the user interacts with the treatment. The treatment testing module 225 may construct a prompt like “Based on User 1's past CTR for a similar treatment, will the user click on the treatment?” For example, the treatment testing module 225 may generate predictions of a received treatment in terms of a CTR for the received treatment. As another example, the output type may be the expected profits for a User across1cross the year. The treatment testing module 225 may generate a prompt like “Based on User 1's past CTR for a similar treatment, what is the estimated CTR of User 1 for the received treatment?” The treatment testing module 225 provides the instruction to the model serving system 150.

The treatment testing module 225 receives a response from the model serving system 150, with at least one or more outputs, where an output is a prediction of how the user will respond to each received treatment. For example, the treatment testing module 225 determines an ideal treatment for the user based on the received output and selects the ideal treatment accordingly.

In another embodiment, the treatment testing module 225 may also instruct the LLM to generate a set of treatments based on the received user's data. The treatment testing module 225 is instructed to generate a prompt to the LLM to generate predictions of how a user responds to the generated set of treatments where a treatment is generated in terms of a desired output type. In another embodiment, the LLM acts as an event generator, and a user's session is identified as a sequence of events (view, clicks, etc.). Therefore, the treatment testing module 225 can provide customer events and associated treatments and request the LLM to predict a sequence of events following a respective treatment. Given a predicted sequence of events across many users, the treatment testing module 225 can execute experiment analysis to obtain metrics of interest. The parameters of the LLM can be fine-tuned based on this information. For example, the parameters of the LLM can be fine-tuned based on prior observed sequences of events or actions based on treatments given for a given user.

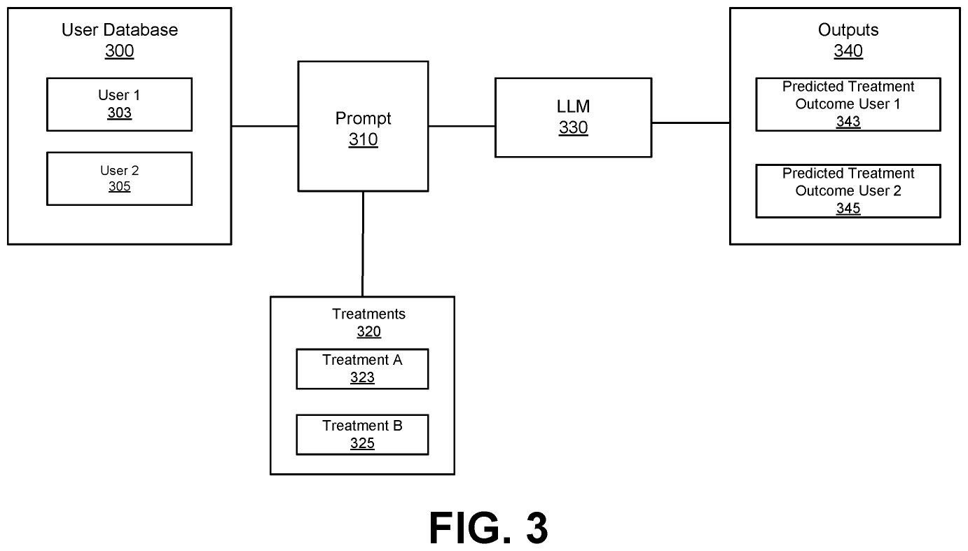

FIG. 3 illustrates an example process of simulating treatment testing for one or more users, in accordance with an embodiment. For example, user database 300 comprises two users: User 1 303 and User 2 305. In one or more embodiments, the user database 300 comprises data for User 1 303 to describe User 1's past behaviors such as engagements on certain simulations or products. For example, User 1 responds positively to coupons of 20% off or more. The prompt 310 is generated by receiving data from a user's database 300 and treatments 320. Treatments 320 comprises a set of treatments comprising Treatment A 323 and Treatment B 325. For example, Treatment A 323, may be a set of 20% off coupons to present and Treatment B 325 may be a set of 25% off coupons. The LLM 330 receives the constructed prompt 310 and transmits the response received from the LLM 330 in a set of outputs 340.

In some embodiments, the predicted treatment User 1 343 is the estimated predictions for the User 1 based on User 1's associated data 303 that predicts how User 1 will respond to each treatment. The prediction treatment for User 1 343 for Treatment A 323 is, for example, whether User 1 will click on a coupon interface of 20% off a set of items. In one embodiment, the predictions in an output for a user is expressed with respect to the output type—for example, a prediction for Treatment A 323 may indicate the expected profit for the user for the coming year if the user was presented with the coupon 20% off at the current time expressed for a series of interfaces presented to the user. As an example, the predicted treatment may determine whether the user will change the user interface theme from the treatment theme presented to the user. As another example, a prediction for Treatment A 323 may indicate the expected CTR likelihood of the user.

In one embodiment, the treatment testing module 225 may select a treatment to present to the user based on the outputs 340 from the LLM 330. In a specific instance, the treatment testing module 225 selects the treatment that has the highest predicted performance based on the results of the simulation, and treats the user with the selected treatment. In this manner, the online concierge system 140 can simulate behavior of users without the negative effects of performing an actual A/B test and treat users with selected treatments that are expected to have good performance for the user.

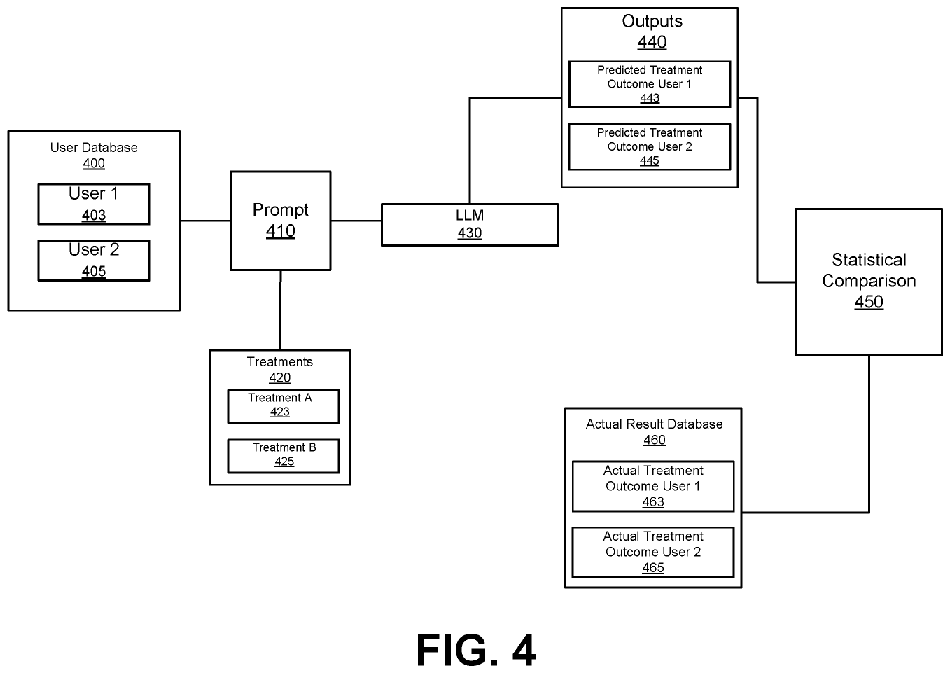

In one embodiment, the treatment testing module 225 incorporates back-testing. As an example, FIG. 4 is a system outline for a module that incorporates back-testing. Specifically, back-testing allows the treatment testing module 225 to obtain the actual outcomes of treating users with certain treatments and compare the actual outcomes to the simulated predictions, so that the treatment testing module 225 can confirm whether the simulations generated by the LLM are reasonably accurate. The set of outputs 440 and the actual treatment database 460 are compared in a statistical comparison 550. The actual treatment database 460 comprises an actual treatment User 1 463 and an actual treatment for User 2 465. In one instance, an actual treatment outcome for a user can be the true outcome for that user when given an actual treatment (not simulated).

In the example illustrated in FIG. 4, the user database 400 and LLM 430 are substantially similar or identical to the structure and functionality of the user database 300 and LLM 330 described in conjunction with FIG. 3. The actual treatment User 1 463 is the actual treatment that is transmitted to the User 1 and the actual outcome for the user (e.g., whether a user clicked on a coupon interface or if a conversion occurred). For example, the actual treatment submitted to User 1 is an engaging coupon of 20% off a set of items.

The treatment testing module 225 performs a statistical comparison 450 to perform back-testing. The statistical comparison may apply one or more statistical metrics that allow the treatment testing module 225 to compare the predictions generated by LLM 430 for a given user to the actual outcomes that were collected for the user. For example, User 1 may have been treated with Treatment A based on simulated outputs 440. Specifically, the simulated prediction for Treatment A may indicate that by presenting the user with Treatment A, there can be an expected profit of $50 for the platform in the coming month. After treating the user with Treatment A, the treatment test module 225 may obtain and compute the profit for the coming month by collecting data for the user, and the actual outcome may indicate $46 of profit for the coming month, which is a small difference. The statistical comparison 450 compares the expected and actual profits, via e.g., average difference over multiple users, variance over multiple users, and the like.

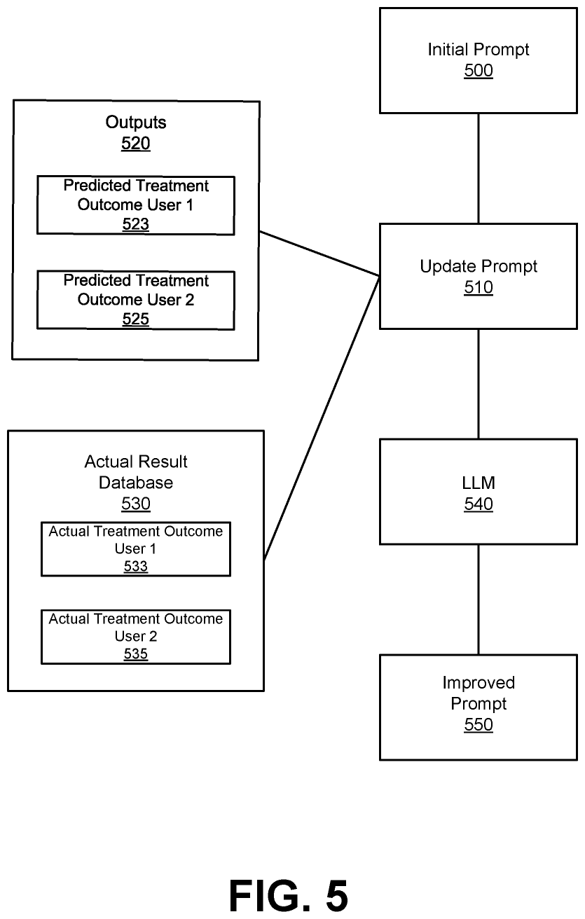

In another embodiment, the treatment testing module 225 utilizes a prompt-tuning system. For example, FIG. 5 is a system outline for prompt tuning the prompt that is transmitted to the LLM 540. The LLM 540 is substantially similar or nearly identical to the LLM 330. The initial prompt 500 comprises an initial prompt that is generated to simulate outputs for a user. The prompt is updated 510 by including a set of simulated outputs 520 and the actual treatment database 530 for one or more users and requesting the LLM 540 to finetune the initial prompt template given the comparison between the actual and predicted outcomes. The updated prompt is transmitted to the LLM 540 where the LLM 540 is instructed to generate an improved prompt based on the received prompt to the LLM 540. The improved prompt 550 is a prompt that is generated such that when provided to the LLM 540 to simulate A/B testing, it allows the LLM 540 to generate better outputs that better align with actual outcomes. For a next user, the test treatment module 225 may use the improved prompt 550 in the future to simulate A/B tests.

The machine learning training module 230 trains machine learning models used by the online concierge system 140. For example, the machine learning module 230 may train the item selection model, the availability model, or any of the machine-learned models deployed by the model serving system 150. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In another embodiment, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

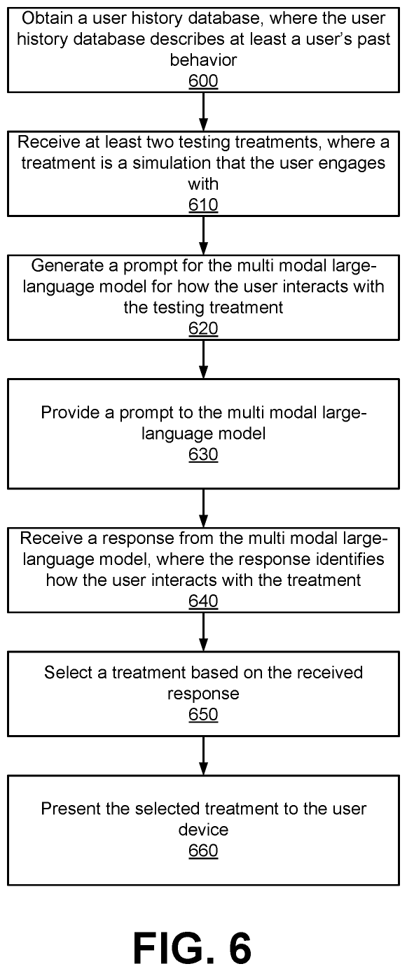

FIG. 6 is a flowchart for a method of a treatment testing module 225 in accordance with some embodiments. Alternative embodiments may include more, fewer, or different steps from those illustrated in FIG. 6, and the steps may be performed in a different order from that illustrated in FIG. 6. These steps may be performed by an online concierge system (e.g., online concierge system 140). Additionally, each of these steps may be performed automatically by the online concierge system without human intervention. A treatment testing module 225 obtains 600 user history data where the user history data describes at least a user's past behavior from users of an online system. The module receives 610 at least two testing treatments, where a treatment may be a simulation that the user engages with. The module generates 620 a prompt for the multi modal large-language model for how the user interacts with the testing treatment based on the received user data. The module provides 630 a prompt to the multi modal large-language model and receives 640 a response from the multi modal large-language model, where the response identifies how the user interacts with the treatment. The treatment testing module selects 650 a treatment based on the received response and presents 660 the selected treatment to the client device associated with the user. In a further embodiment, the user history database may be updated to include the user's response to the selected treatment.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining a user history database, wherein the user history database data describes at least a user's past behavior;
receiving at least two treatments, wherein the treatment comprises a candidate interaction the user engages with;
generating a prompt for a machine learning language model including the at least two treatments, the user history database, and a request to generate predictions of an output of a desired output type, wherein the output type indicates how the user will interact with the treatment;
providing the prompt to a model serving system, hosting the machine learned language model, for execution;
receiving a response from the model serving system, wherein the response includes an output, and wherein the output indicates a prediction of the desired output type on how the user will respond to each received treatment;
selecting, a treatment based on the received prediction of the user; and
responsive to selecting the treatment based for the user, presenting the selected treatment to a user device associated with the user.

2. The method of claim 1, wherein the at least two treatments are generated by the machine learned language model.

3. The method of claim 1, further comprising:
obtaining an actual treatment database, wherein the actual treatment database includes an actual outcome of the user for a treatment selected for the user; and
statistically comparing the prediction for the selected treatment to the actual outcome of the user.

4. The method of claim 1, further comprising:
obtaining an actual treatment database, wherein the actual treatment database includes an actual outcome of the user for a treatment selected for the user;
generating a second prompt for the machine learned language model including a first prompt template, at least the actual outcome and the prediction for the selected treatment for the user, and a request to generate an updated prompt;
receiving a second response including the updated prompt; and
simulating behavior for the at least two treatments for a second user using the updated prompt.

5. The method of claim 1, wherein selecting the a treatment comprises selecting a presentation of content to the user to induce a desired behavior from the user.

6. The method of claim 1, further comprising:
obtaining an actual treatment database, wherein the actual treatment database includes an actual outcome of the user for a treatment selected for the user; and
finetune parameters of the machine learning language model using the actual treatment database as a training dataset.

7. The method of claim 1, wherein obtaining the user history database includes obtaining a list of products the user purchased, content interacted by the user, or geographical location of the user.

8. A non-transitory computer-readable storage medium storing instructions that when executed by a computer process cause the computer processor to perform steps comprising:
obtaining a user history database, wherein the user history database data describes at least a user's past behavior;
receiving at least two treatments, wherein the treatment comprises a candidate interaction the user engages with;
generating a prompt for a machine learning language model including the at least two treatments, the user history database, and a request to generate predictions of an output of a desired output type, wherein the output type indicates how the user will interact with the treatment;
providing the prompt to a model serving system, hosting the machine learned language model, for execution;
receiving a response from the model serving system, wherein the response includes an output, and wherein the output indicates a prediction of the desired output type on how the user will respond to each received treatment;
selecting, a treatment based on the received prediction of the user; and
responsive to selecting the treatment based for the user, presenting the selected treatment to a user device associated with the user.

9. The non-transitory computer-readable storage medium of claim 8, wherein the at least two treatments are generated by the machine learned language model.

10. The non-transitory computer-readable storage medium of claim 8, further comprising:
obtaining an actual treatment database, wherein the actual treatment database includes an actual outcome of the user for a treatment selected for the user; and
statistically comparing the prediction for the selected treatment to the actual outcome of the user.

11. The non-transitory computer-readable storage medium of claim 8, further comprising:
obtaining an actual treatment database, wherein the actual treatment database includes an actual outcome of the user for a treatment selected for the user;
generating a second prompt for the machine learned language model including a first prompt template, at least the actual outcome and the prediction for the selected treatment for the user, and a request to generate an updated prompt;
receiving a second response including the updated prompt; and
simulating behavior for the at least two treatments for a second user using the updated prompt.

12. The non-transitory computer-readable storage medium of claim 8, wherein selecting the treatment comprises selecting a presentation of content to the user to induce a desired behavior from the user.

13. The non-transitory computer-readable storage medium of claim 8, further comprising:
obtaining an actual treatment database, wherein the actual treatment database includes an actual outcome of the user for a treatment selected for the user; and
finetuning parameters of the machine learning language model using the actual treatment database as a training dataset.

14. The non-transitory computer-readable storage medium of claim 8, wherein obtaining the user history database includes obtaining a list of products the user purchased, content interacted by the user, or geographical location of the user.

15. A computer system for evaluating a machine learning model, the system comprising:
a computer processor; and
a non-transitory computer-readable storage medium storing instructions that when executed by a computer processor cause the computer processor to perform steps comprising:
obtaining a user history database, wherein the user history database data describes at least a user's past behavior;
receiving at least two treatments, wherein the treatment comprises a candidate interaction the user engages with;
generating a prompt for a machine learning language model including the at least two treatments, the user history database, and a request to generate predictions of an output of a desired output type, wherein the output type indicates how the user will interact with the treatment;
providing the prompt to a model serving system, hosting the machine learned language model, for execution;
receiving a response from the model serving system, wherein the response includes an output, and wherein the output indicates a prediction of the desired output type on how the user will respond to each received treatment;
selecting, a treatment based on the received prediction of the user; and
responsive to selecting the treatment based for the user, presenting the selected treatment to a user device associated with the user.

16. The computer system of claim 15, wherein the at least two treatments are generated by the machine learned language model.

17. The computer system of claim 15, further comprising:
obtaining an actual treatment database, wherein the actual treatment database includes an actual outcome of the user for a treatment selected for the user; and
statistically comparing the prediction for the selected treatment to the actual outcome of the user.

18. The computer system of claim 15, further comprising:
obtaining an actual treatment database, wherein the actual treatment database includes an actual outcome of the user for a treatment selected for the user;
generating a second prompt for the machine learned language model including a first prompt template, at least the actual outcome and the prediction for the selected treatment for the user, and a request to generate an updated prompt;
receiving a second response including the updated prompt; and
simulating behavior for the at least two treatments for a second user using the updated prompt.

19. The computer system of claim 15, wherein selecting the treatment comprises selecting a presentation of content to the user to induce a desired behavior from the user.

20. The computer system of claim 15, further comprising:
obtaining an actual treatment database, wherein the actual treatment database includes an actual outcome of the user for a treatment selected for the user; and
finetuning parameters of the machine learning language model using the actual treatment database as a training dataset.
